(19) United States
(12) Patent Application Publication
(10) Pub. No.: US 2022/0158236 A1
(43) Pub. Date: May 19, 2022

(54) SOLID ELECTROLYTE, ENERGY STORAGE DEVICE, AND METHOD FOR PRODUCING SOLID ELECTROLYTE

(71) Applicant: NIPPON CHEMI-CON CORPORATION, Tokyo (JP)

(72) Inventors: Yasuyoshi Shiraishi, Kanagawa (JP); Satoshi KUBOTA, Tokyo (JP); Shuichi ISHIMOTO, Tokyojp (JP); Shun KOIKAWA, Kanagawa (JP)

(21) Appl. No.: 17/440,432

(22) PCT Filed: Mar. 9, 2020
(86) PCT No.: PCT/JP2020/010053

§ 371 Date: Sep. 17, 2021

(30) Foreign Application Priority Data
Mar. 29, 2019 (JP) 2019-066123
Aug. 16, 2019 (JP) 2019-149290

(51) Int. Cl. H01M 10/0565; H01G 11/56

(52) U.S. Cl. CPC H01M 10/0565; H01M 2300/0082; H01G 11/56

(57) ABSTRACT

A plastic-crystal-based solid electrolyte with high ion conductivity and a power storage device using said solid electrolyte are provided. The plastic crystal includes two different types of anions selected from a group of various amide anions in which two hydrogen atoms of NH₂ anion are substituted with perfluoroalkylsulfonyl group, fluorosulfonyl group, or both, and tris(trifluoromethanesulfonyl)metanide anion, or the plastic crystal includes anions selected one each from the first group, and a second group of hexafluorophosphate anion, various perfluoroalkylphosphate anions in which a part of fluorine atoms of PF₆ is substituted with fluoroalkyl group, and various perfluoroalkylborate anions in which a part of fluorine atoms of BF₄ anion is substituted with fluoroalkyl group.

### FIELD OF INVENTION

The present disclosure relates to a solid electrolyte including plastic crystals, a power storage device using said solid electrolyte, and a method for producing said solid electrolyte.

### BACKGROUND

Power storage devices such as secondary batteries, electric double-layer capacitors, fuel cells, and solar batteries are generally formed by making a positive electrode and a negative electrode to face each other with an electrolyte layer therebetween. A lithium-ion secondary battery has Faraday reaction electrodes, and charges and discharges electric energy by reversibly inserting and desorbing lithium ions in the electrolyte layer relative to the electrodes. One or both of the electrodes of the electric double-layer capacitor are polar electrodes, and the electric double-layer capacitor utilizes the power storage effect of the electric double-layer capacitor which is formed on an interface between the polar electrode and the electrolyte layer to charge and discharge.

A solid electrolyte layer may be selected as the electrolyte layer of the power storage device. A region of the solid electrolyte layer where the chemical reaction of the electrodes, such as hydration deterioration, occurs are limited to vicinity of the electrode. Therefore, leakage current is small compared with a case of an electrolytic solution, and self-discharge is suppressed. Furthermore, the production amount of gas due to the chemical reaction with the electrodes is smaller compared with the case of the electrolytic solution, so that the opening of valves and the leakage can be reduced.

As the solid electrolyte, sulfide-based solid electrolytes such as Li₂S.P₂S₅, oxide-based solid electrolytes such as Li₇La₃Zr₂O₁₂, plastic-crystal-based solid electrolytes, for example, having N-ethyl-N-methyl pyrrolidinium (P12) as cations and bis(fluorosulfonyl)amide (FSA) as anions, and polymer-based solid electrolytes such as polyethylene glycol are known. Note that, in the secondary battery, lithium ions are doped to a selected matrix as the electrolyte if necessary, and in the electric double-layer capacitor, for example, TEMABF₄ is doped to a selected matrix as the electrolyte if necessary.

The plastic crystals are soluble in organic solution. On the other hand, the sulfide-based solid electrolyte and the oxide-based solid electrolyte are insoluble. Therefore, when the plastic crystal is employed as the solid electrolyte or the matrix of the solid electrolyte, the production method in which anion components and cation components of the plastic crystal, or salts thereof are dissolved in solvent and are casted to the electrode can be employed. Accordingly, the plastic-crystal-based solid electrolyte are advantageous in that their adhesion to the electrode is improved and it is easier to get into a porous structure when an active material phase pf the electrode is said porous structure, compared to the sulfide-based solid electrolyte and the oxide-based solid electrolyte.

### PRIOR ART DOCUMENT

### Patent Document

Patent Document 1: Japanese Patent Publication No. 2014-504788
Patent Document 2: Japanese Laid-Open Application No. 2017-91813

### SUMMARY OF INVENTION

### Problems to be Solved by Invention

However, it is pointed out that the ion conductivity of the plastic-crystal-based solid electrolyte is low by two or three digits compared to the sulfide-based solid electrolyte and the oxide-based solid electrolyte. For example, it is reported that a solid electrolyte including plastic crystals consisting of N,N-diethylpyrrolidinium cations and bis(fluorosulfonyl)amide anions has the ion conductivity of 1×10⁻⁵ S/cm order in environment of 25° C. Also, it is reported that a solid electrolyte including plastic crystals consisting of N,N-dimethylpyrrolidinium cations and bis(trifluoromethanesulfonyl)amide anions has the ion conductivity of 1×10⁻⁸ S/cm order.

In contrast, for example, it is reported that a Li₂S.P₂S₅ solid electrolyte has the ion conductivity of 1×10⁻² S/cm order. Also, it is reported that a Li₇La₃Zr₂O₁₂ solid electrolyte has the ion conductivity of 1×10⁻³ S/cm order.

The present disclosure is suggested to address the above-described problem, and the objective is to provide a plastic-crystal-based solid electrolyte with high ion conductivity and a power storage device using said solid electrolyte.

### Means to Solve the Problem

The inventors have well studied and found that the ion conductivity of the solid electrolyte is improved when two types of specific anions that can form a plastic crystal is mixed and used, compared with a case where single specific anion is used. Furthermore, the ion conductivity is improved by any known cations that form a plastic crystal as long as they can form a plastic crystal, that is, they are in the solid state but not an ionic solution in predetermined usage temperature.

The present disclosure is based on this finding, and to address the above-described problem, a solid electrolyte according to the present disclosure includes a plastic crystal to which an electrolyte is doped, in which the plastic crystal includes two different types of anions selected from a group of various amide anions in which two hydrogen atoms of NH₂ anion are substituted with perfluoroalkylsulfonyl group, fluorosulfonyl group, or both, and tris(trifluoromethanesulfonyl)metanide anion.

Furthermore, the present disclosure is based on this finding, and to address the above-described problem, a solid electrolyte according to the present disclosure includes a plastic crystal to which an electrolyte is doped, in which the plastic crystal includes anions selected one each from a first group and a second group, the first group is a group of various amide anions in which two hydrogen atoms of NH₂ anion is substituted with perfluoroalkylsulfonyl, fluorosulfonyl, or both, and tris(trifluoromethanesulfonyl)metanide anion, and the second group is a group of hexafluorophosphate anion, various perfluoroalkylphosphate anions in which a part of fluorine atoms of PF₆ is substituted with fluoroalkyl group, and various perfluoroalkylborate anions in which a part of fluorine atoms of BF₄ anion is substituted with fluoroalkyl group.

Furthermore, the present disclosure is based on this finding, and to address the above-described problem, a solid electrolyte according to the present disclosure includes a plastic crystal to which an electrolyte is doped, in which the plastic crystal includes anions selected one each from a first group and a second group, the first group is a group of various amide anions in which two hydrogen atoms of NH₂ anion is substituted with perfluoroalkylsulfonyl, fluorosulfonyl, or both, and tris(trifluoromethanesulfonyl)metanide anion, and the second group is a group of various perfluoroalkylsulfonic acid anions in which hydrocarbon group extending from sulfonic acid skeleton is substituted with perfluoroalkyl group.

Various amide anions may be various bis(perfluoroalkylsulfonyl)amide anion represented by the below chemical formula (A), bis(fluorosulfonyl)amide anion, and various N-(fluorosulfonyl)-N-(perfluoroalkylsulfonyl)amide anions, N,N-hexafluoro-1,3-disulfonylaminde anion represented by the below chemical formula (B), and N,N-pentafluoro-1,3-disulfonylamide represented by the below chemical formula (C). The present disclosure includes the plastic crystal including two types of bis(perfluoroalkylsulfonyl)amide anions with different numbers of carbon in perfluoroalkylsulfonyl, and the plastic crystal including two types of N-(fluorosulfonyl)-N-(perfluoroalkylsulfonyl)amide anions with different numbers of carbon in perfluoroalkylsulfonyl.

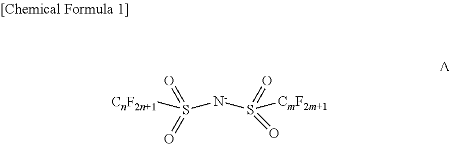

[In the formula, n and m are integers equal to or greater than 0, and number of carbons is arbitrary]

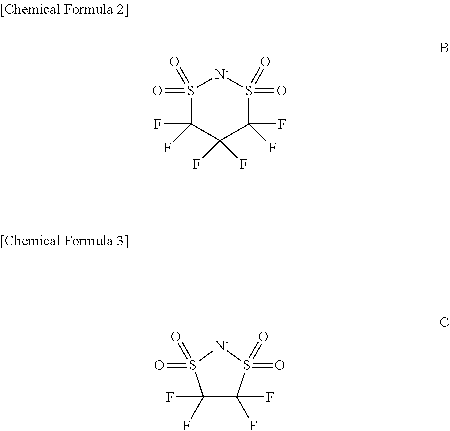 [SMILES: O=S1(=O)[N-]S(=O)(=O)C(F)(F)C(F)(F)C1(F)F ; O=S1(=O)[N-]S(=O)(=O)C(F)(F)C1(F)F]

Various perfluoroalkylphosphate anions are tris(fluoroalkyl)trifluorophosphate anion represented by the below chemical formula (D), and various perfluoroalkylborate anions may be mono(fluoroalkyl)trifluoroborate anion represented by the below chemical formula (E) or bis(fluoroalkyl)fluoroborate anion.

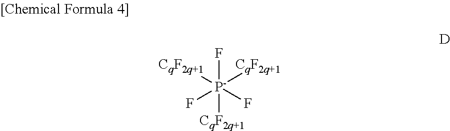

[In the formula, q is an integer equal to or greater than 1, and number of carbons is arbitrary]

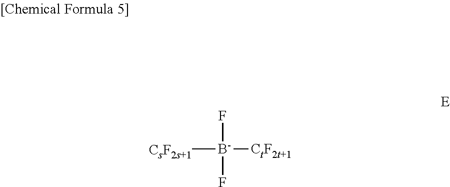

[In the formula, s is an integer equal to or greater than 0, t is an integer equal to or greater than 1, and number of carbons is arbitrary]

Note that tris(trifluoromethanesulfonyl)metanide anion is represented by the below chemical formula (F).

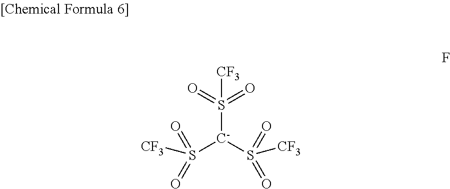 [SMILES: O=S(=O)([C-](S(=O)(=O)C(F)(F)F)S(=O)(=O)C(F)(F)F)C(F)(F)F]

Various perfluoroalkylsulfonic acid anions may be trifluoromethanesulfonic acid anion represented by the below chemical formula (Z), pentafluoroethylsulfonic acid anion, heptafluoropropanesulfonic acid anion, and nonafluorobutanesulfonic acid anion.

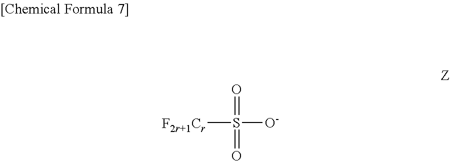

[In the formula, r is an integer equal to or greater than 1 and equal to or smaller than 4]

A mixture ratio of the two types of anions may be within a range of 10:90 to 90:10 in molecular ratio. Furthermore, the mixture ratio of the two types of anions may be within a range of 20:80 to 80:20 in molecular ratio.

A mixture ratio (A):(B) of the anion (A) selected from the first group and the anion (B) selected from the group of the various perfluoroalkylsulfonic acid anions that are the second group may be in a range of 85:15 to 20:80 in molecular ratio.

The mixture ratio (A):(B) of the anion (A) selected from the first group and the anion (B) selected from the group of the various perfluoroalkylsulfonic acid anions that are the second group may be in a range of 80:20 to 50:50 in molecular ratio.

A power storage device using the solid electrolyte is one aspect of the present disclosure.

Furthermore, a method for producing the solid electrolyte according to the present disclosure is based on the finding, and in order to address the above-described problem, the method includes a process of producing a plastic crystal including two different types of anions selected from a group of various amide anions in which two hydrogen atoms of NH₂ anion is substituted with a perfluoroalkylsulfonyl group, fluorosulfonyl group, or both, and tris(trifluoromethanesulfonyl)metanide anion.

Furthermore, a method for producing the solid electrolyte according to the present disclosure is based on the finding, and in order to address the above-described problem, the method includes a process of producing a plastic crystal including anions selected one each from a first group and a second group, in which the first group is a group of various amide anions in which two hydrogen atoms of NH₂ anion is substituted with perfluoroalkylsulfonyl, fluorosulfonyl, or both, and tris(trifluoromethanesulfonyl)metanide anion, and the second group is a group of hexafluorophosphate anion, various perfluoroalkylphosphate anions in which a part of fluorine atoms of PF₆ is substituted with fluoroalkyl group, and various perfluoroalkylborate anions in which a part of fluorine atoms of BF₄ anion is substituted with fluoroalkyl group.

Furthermore, a method for producing the solid electrolyte according to the present disclosure is based on the finding, and in order to address the above-described problem, the method includes a process of producing a plastic crystal includes anions selected one each from a first group and a second group, in which the first group is a group of various amide anions in which two hydrogen atoms of NH₂ anion is substituted with perfluoroalkylsulfonyl, fluorosulfonyl, or both, and tris(trifluoromethanesulfonyl)metanide anion, and the second group is a group of various perfluoroalkylsulfonic acid anions in which hydrocarbon group extending from sulfonic acid skeleton is substituted with perfluoroalkyl group.

### Effect of Invention

According to the present disclosure, the ion conductivity of the solid electrolyte using the plastic crystal is improved.

### BRIEF DESCRIPTION OF DRAWINGS

FIG. 1 is a graph indicating an ion conductivity relative to a mixture ratio of two types of anions of the first combination.

FIG. 2 is a graph indicating an ion conductivity relative to a mixture ratio of two types of anions of the second combination.

### EMBODIMENTS

In below, embodiments of the present disclosure will be described. Note that the present disclosure is not limited to the below-described embodiments.

(Solid Electrolyte)

A solid electrolyte is present between a positive electrode and a negative electrode of a power storage device and mainly conducts ions. The power storage device is a passive element which charges and discharges electric energy and is, for example, a lithium-ion secondary battery and a electric double-layer battery, etc. The lithium-ion has Faraday reaction electrodes, and charges and discharges electric energy by reversibly inserting and desorbing lithium ions in the solid electrolyte relative to the electrodes. One or both of the electrodes of the electric double-layer capacitor are polar electrodes, and the electric double-layer capacitor utilizes the power storage effect of the electric double-layer capacitor which is formed on an interface between the polar electrode and the electrolyte layer to charge and discharge.

In the solid electrolyte, a matrix thereof is formed by a plastic crystal that is the ion conductive medium, and the solid electrolyte includes an ionic salt, which is doped to said plastic crystal, as the electrolyte. Furthermore, the solid electrolyte may include a polymer, The plastic crystal is also referred to as a plastic crystal and has chemical order and disorder. That is, the plastic crystal has three-dimensional crystal lattice structure in which anions and cations are regularly arranged. On the other hand, these anions and cations have rotational irregularity. In the plastic crystal, positive ions and negative ions produced by separation of the electrolyte hops by the rotation of the anions and the cations and moves in a gap in the crystal lattice.

The plastic crystal is formed by at least two types of anions. Two types of anions are selected from a group of various amide anions and tris(trifluoromethanesulfonyl)metanide anion. In the various anions, two hydrogen atoms of NH₂ anion are substituted with perfluoroalkylsulfonyl group, fluorosulfonyl group, or both. If these anions are included, another anion may be added so that the plastic crystal includes more than three types of anions.

For example, the various anions include a straight chain anion, and include various bis(perfluoroalkylsulfonyl)amide anions represented by the below chemical formula (A), bis(fluorosulfonyl)amide anion, and various N-(fluorosulfonyl)-N-(perfluoroalkylsulfonyl) amide anions.

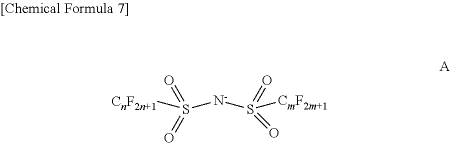

In the formula, n and m are integers equal to or greater than 0, and number of carbons is arbitrary

In the chemical formula (A), if n and m is equal to or greater than 1, the anion is bis(perfluoroalkylsulfonyl)amide anion. In detail, as bis(perfluoroalkylsulfonyl)amide anion, bis(trifluoromethanesulfonyl)amide anion (TFSA anion) represented by the below chemical formula (G) and bis(pentafluoroethylsulfonyl)amide anion (BETA anion) represented by the below chemical formula (H) may be cited.

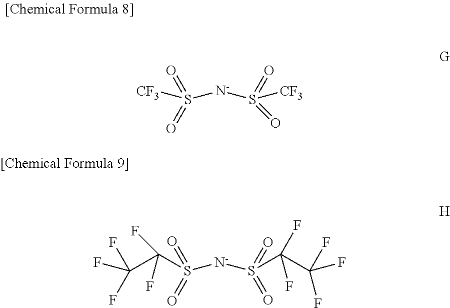 [SMILES: O=S(=O)([N-]S(=O)(=O)C(F)(F)F)C(F)(F)F ; O=S(=O)([N-]S(=O)(=O)C(F)(F)C(F)(F)F)C(F)(F)C(F)(F)F]

In the chemical formula (A), a group with zero carbon is fluorosulfonyl group, and if n and m is 0, the anion is bis(fluorosulfonyl)amide anion (FSA anion) represented by the below chemical formula (I).

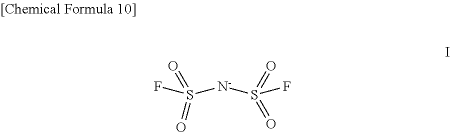

In the chemical formula (A), if n is 0 and m is equal to or greater than 1, the anion is N-(fluorosulfonyl)-N-(perfluoroalkylsulfonyl)amide anion represented by the below chemical formula (J).

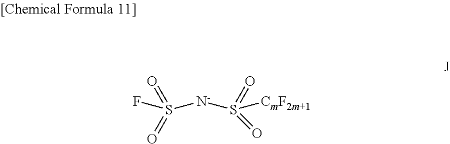

Furthermore, the various amide anions include, for example, heterocyclic anions having five-membered ring and six-membered ring, and include N,N-hexafluoro-1,3-disulfonylamide anion (CFSA anion) represented by the below chemical formula (B) and N,N-pentafluoro-1,3-disulfonylamide represented by the below chemical formula (C).

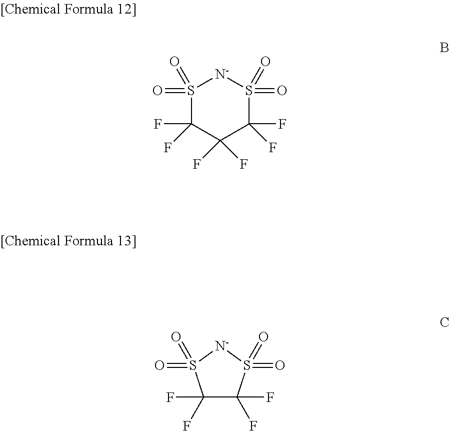 [SMILES: O=S1(=O)[N-]S(=O)(=O)C(F)(F)C(F)(F)C1(F)F ; O=S1(=O)[N-]S(=O)(=O)C(F)(F)C1(F)F]

Note that tris(trifluoromethanesulfonyl)metanide anion (TFSM anion) is represented by the below chemical formula (F).

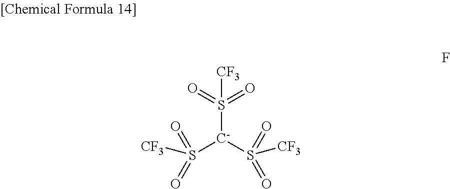 [SMILES: O=S(=O)([C-](S(=O)(=O)C(F)(F)F)S(=O)(=O)C(F)(F)F)C(F)(F)F]

For example, the plastic crystal may include two types of TFSA anion and BETA anion, may include two types of N-(fluorosulfonyl)-N-(trifluoromethylsulfonyl)amide anion and TFSA anion, may include two types of N-(fluorosulfonyl)-N-(trifluoromethylsulfonyl)amide anion and N-(fluorosulfonyl)-N-(pentafluoroethylsulfonyl)amide anion, and may include two types of FSA anion and CFSA anion.

It is assumed that the crystal structure is changed from the plastic crystal with one type of anion to the mixture of two types of anions, and this change facilitates hopping of the anions and cations in the electrolyte, improving the ion conductivity of the solid electrolyte, however, the mechanism is not limited thereto. Therefore, the mixture ratio of the two types may be arbitrary if the crystal structure changes compared to the case with single anion.

However, the ion conductivity of the solid electrolyte is significantly improved when the mixture ratio of the two types of anions is within the range of 10:90 to 90:10 in molecular ratio, that is, when the mixture proportion of one of the two types of anions relative to the total number of moles of anions forming the plastic crystal is within the range of 10 mol % to 90 mol %. In particular, the ion conductivity of the solid electrolyte is further significantly improved when the mixture ratio of the two types of anions is within the range of 20:80 to 80:20 in molecular ratio, that is, when the mixture proportion of one of the two types of anions relative to the total number of moles of anions forming the plastic crystal is within the range of 20 mol % to 80 mol %.

Furthermore, a first group includes various amide anions in which two hydrogen atoms of NH₂ anion is substituted with perfluoroalkylsulfonyl, fluorosulfonyl, or both, and tris(trifluoromethanesulfonyl)metanide anion. In addition, a PB-based second group includes hexafluorophosphate anion (PF₆ anion), various perfluoroalkylphosphate anions in which a part of fluorine atoms of PF₆ is substituted with fluoroalkyl group, and various perfluoroalkylborate anions in which a part of fluorine atoms of BF₄ anion is substituted with fluoroalkyl group. At this time, the plastic crystal may at least include and be formed by one type of anion selected from the first group and one type of anion selected from the PB-based second group. If these anions are included, another anion may be added so that more than three types of anions are included.

Tris(fluoroalkyl)trifluorophosphate anion represented by the below chemical formula (D) may be cited as the various perfluoroalkylphosphate anions.

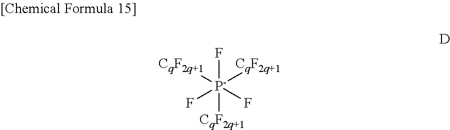

In the chemical formula (D), q is an integer equal to or more than, and number of carbons is arbitrary.

In detail, tris(pentafluoroethyl)trifluorophosphate anion (FAP anion) represented by the below chemical formula (K) may be cited.

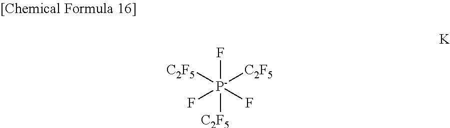

Mono(fluoroalkyl)trifluoroborate anion represented by the below chemical formula (E) and bis(fluoroalkyl)fluoroborate anion may be cited as the various perfluoroalkylborate anions.

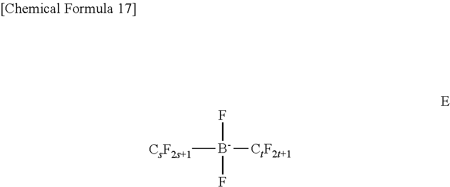

In the chemical formula, s is an integer equal to or greater than 0, t is an integer equal to or greater than 1, and number of carbons is arbitrary.

In the chemical formula (E), if s is 0 and t is equal to or greater than 1, the anion is mono(fluoroalkyl)trifluoroborate anion represented by the below chemical formula (L). In detail, mono(trifluoromethyl)trifluoroborate anion represented by the below chemical formula (M) may be cited.

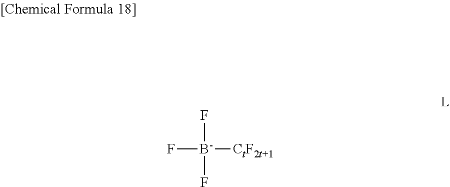

In the chemical formula, t is an integer equal to or more than 1, and number of carbons is arbitrary.

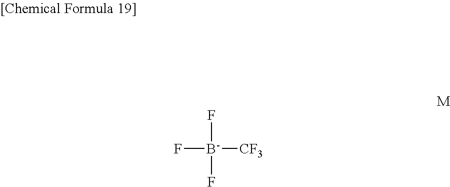

It is assumed that the crystal structure of the plastic crystal formed by one type of anion among the first group changes when the anion of the PB-based second group is included, and this change facilitates hopping of the anions and cations in the electrolyte, improving the ion conductivity of the solid electrolyte, however, the mechanism is not limited thereto. Therefore, the mixture ratio of the two types selected one each from the first group and the PB-based second group may be arbitrary if the crystal structure changes.

However, the ion conductivity of the solid electrolyte is significantly improved when the mixture ratio of the two types of anions is within the range of 10:90 to 90:10 in molecular ratio, that is, when the mixture proportion of one of the two types of anions relative to the total number of moles of anions forming the plastic crystal is within the range of 10 mol % to 90 mol %. In particular, the ion conductivity of the solid electrolyte is further significantly improved when the mixture ratio of the two types of anions is within the range of 20:80 to 80:20 in molecular ratio, that is, when the mixture proportion of one of the two types of anions relative to the total number of moles of anions forming the plastic crystal is within the range of 20 mol % to 80 mol %.

Furthermore, a first group includes various amide anions in which two hydrogen atoms of NH₂ anion is substituted with perfluoroalkylsulfonyl group, fluorosulfonyl group, or both, and tris(trifluoromethanesulfonyl)metanide anion. In addition, a S-based second group includes various perfluoroalkyl sulfonic acid anions in which hydrocarbon group extending from sulfonic acid skeleton is substituted with perfluoroalkyl group. At this time, the plastic crystal may at least include and be formed by one type of anion selected from the first group and one type of anion selected from the S-based second group. If these anions are included, another anion may be added so that more than three types of anions are included.

Various perfluoroalkyl sulfonic acid anions are represented by the below chemical formula (Z).

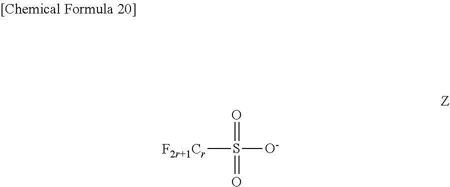

In the chemical formula (Z), r is an integer equal to or greater than 1 and equal to or smaller than 4.

Also in this combination of the first group and the S-based second group, it is assumed that the crystal structure of the plastic crystal formed by one type of anion among the first group changes when the anion of the S-based second group is included, and this change facilitates hopping of the anions and cations in the electrolyte, improving the ion conductivity of the solid electrolyte, however. Therefore, the mixture ratio of the two types selected one each from the first group and the S-based second group may be arbitrary if the crystal structure changes. The ion conductivity of the solid electrolyte is significantly improved when the mixture ratio of the two types of anions is within the range of 10:90 to 90:10 in molecular ratio and the ion conductivity of the solid electrolyte is further significantly improved when the mixture ratio of the two types of anions is within the range of 20:80 to 80:20 in molecular ratio. the ion conductivity of the solid electrolyte is further significantly improved when the mixture ratio of the S-based second group is 20% or more and 60% or less.

In detail, it is preferable that the various perfluoroalkylsulfonic acid anions are trifluoromethanesulfonic acid anion in which r is 1 in the chemical formula (Z), pentafluoroethanesulfonic acid anion in which r is 2 in the chemical formula (Z), heptafluoropropanesulfonic acid anion in which r is 3 in the chemical formula (Z), and nonafluorobutanesulfonic acid anion in which r is 4 in the chemical formula (Z).

Furthermore, when trifluoromethanesulfonic acid anion, pentafluoroethanesulfonic acid anion, heptafluoropropanesulfonic acid anion, or nonafluorobutanesulfonic acid anion are selected from the S-based second group, the decrease in the ion conductivity of the plastic crystal in the low-temperature environment such as at the temperature of 0° C. or less can be suppressed. These perfluoroalkylsulfonic acid anions have an asymmetric structure in which perfluoroalkyl group extends toward one direction when sulfone group is regarded as the central skeleton. This asymmetric structure suppresses the decrease in the ion conductivity of the plastic crystal in the low-temperature environment.

From the viewpoint of the ion conductivity in the low-temperature environment, it is preferable that perfluoroalkylsulfonic acid anion is within the range of 20 mol % to 50 mol % relative to total number of moles of anions forming the plastic crystal. In other word, it is preferale that the mixture ratio of perfluoroalkylsulfonic acid anion and the other anion is within the range of 2:8 to 5:5 in molecular ratio. The decrease in the ion conductivity of the plastic crystal in the low-temperature environment can be particularly suppressed when the mixture ratio is within said range.

The cation forming the plastic crystal may be any known cations as long as the cation can form the plastic crystal while maintaining the solid state and in the usage temperature range of the power storage device without becoming ionic solution. It is desirable that the cation has moles equivalent to the total amount of anions forming the plastic crystal. Typically, quaternary ammonium cation and quaternary phosphonium cation may be cited as the cation.

As quaternary ammonium cation, tetraalkylammonium cation represented by the below chemical formula (N) in which hydrogen atoms are substituted by straight chain alkyl group with arbitrary number of carbons, such as triethylmethylammonium cation (TEMA cation), pyrrolidinium cation represented by the below chemical formula (P) having five-membered ring to which methyl group, ethyl group, or isopropyl group is bonded, piperidinium cation represented by the below chemical formula (Q) having six-membered ring to which methyl group, ethyl group, or isopropyl group is bonded, and spiro-type pyrrolidinium cation (SBP cation) represented by the below chemical formula (R) may be cited.

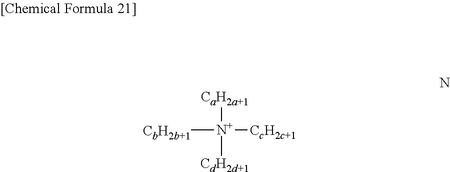

In the formula, a, b, c, and d are an integer equal to or more than 1, and number of carbons is arbitrary.

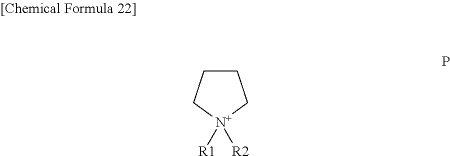

In the formula, R1 an R2 are methyl group, ethyl group, or isopropyl group.

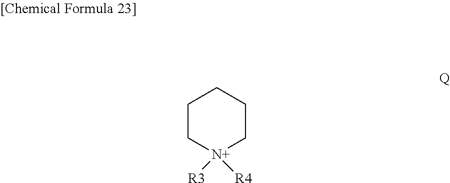

In the formula, R3 an R4 are methyl group, ethyl group, or isopropyl group.

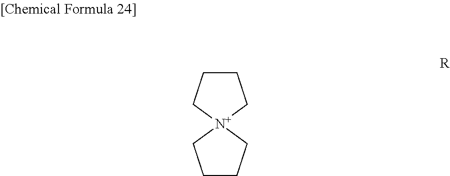

As detailed examples of pyrrolidinium cation generalized by the above chemical formula (P), N-ethyl-N-methylpyrrolidinium cation (P12 cation) represented by the below chemical formula (S), N-isopropyl-N-methylpyrrolidinium cation (P13 iso cation) represented by the below chemical formula (T), and N,N-diethylpyrrolidinium cation (P22 cation) represented by the below chemical formula (U) may be cited. Also, as detailed examples of piperidinium cation generalized by the above chemical formula (Q), for example, N-ethyl-N-methylpiperidinium cation (P12 cation having six-membered ring) represented by the below chemical formula (V) may be cited.

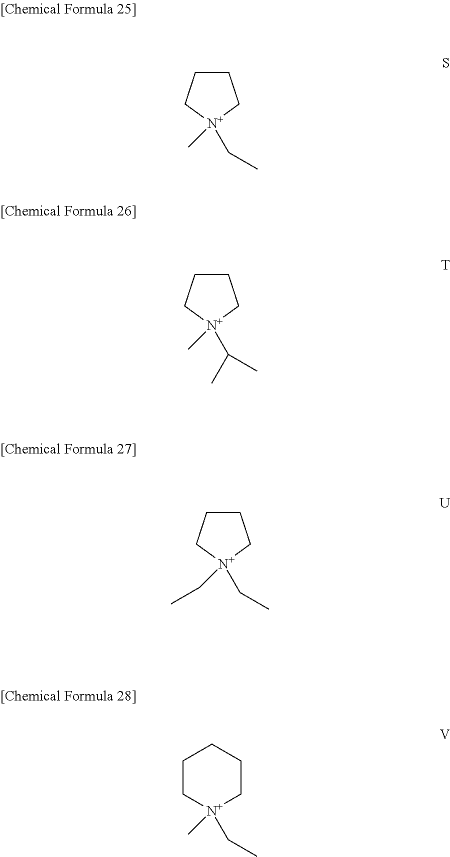

Furthermore, as quaternary phosphonium cation, tetraalkylphosphonium cation represented by the below formula (W) in which hydrogen atoms are substituted by straight chain alkyl group with arbitrary number of carbons may be cited. As tetraalkylphosphonium cation, for example, tetraethylphosphonium cation (TEP cation) may be cited.

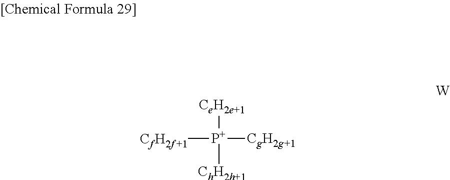

In the formula, e, f, g, and h are an integer equal to or more than 1, and number of carbons is arbitrary.

An ionic salt which is doped to the plastic crystal and becomes the electrolyte may depend on the type of the power storage device. As the ionic salt for the lithium-ion secondary battery, Li(CF₃SO₂)₂N (referred to as LiTFSA), Li(FSO₂)₂N (referred to as LiFSA), Li(C₂F₅SO₂)₂N, LiPF₆, LiBF₄, LiAsF₆, LiTaF₆, LiClO₄, LiCF₃SO₃ may be used in single or in combination of two or more. As the ionic salt for the electric double-layer capacitor, organic acid salt, inorganic acid salt, compound salt of organic acid and inorganic acid may be used in single or in combination of two or more.

As the organic acid, carboxylic acid such as oxalic acid, succinic acid, glutaric acid, pimelic acid, suberic acid, sebacic acid, phthalic acid, isophthalic acid, terephthalic acid, maleic acid, adipic acid, benzoic acid, toluic acid, enanthic acid, malonic acid, 1,6-decanecarboxylic acid, 1,7-octanecarboxylic acid, azelaic acid, undecanedioic acid, dodecanedioic acid, and tridecanedioic acid, phenol, and sulfonic acid may be cited. Also, as the inorganic acid, boric acid such as tetrafluoroborate, phosphoric acid, phosphorus acid, hypophosphorus acid, carbonic acid, and silicic acid may be cited. As the compound of organic acid and inorganic acid, borodisalicylic acid, borodioxalic acid, and borodiglycolic acid may be cited.

As the organic salt, the inorganic salt, and at least one type of the compound salt of organic acid and inorganic acid, ammonium salt, quaternary ammonium salt, quaternary aminidium salt, amine salt, sodium salt, and potassium salt, etc., may be cited. As the quaternary ammonium ion of quaternary ammonium salt, tetramethylammonium, triethykmethylammonium, and triethylammonium, etc., may be cited. As the quaternary aminidium salt, ethyldimethylimidazolium and tatramethylimidazolium, etc., may be cited. As amine of the amine salt, primary amine, secondary amine, and tertiary amine may be cited. As the primary amine, methyl amine, ethyl amine, and propylamine, etc., may be cited. As the secondary amine, dimethylamine, diethylamine, ethylmethylamine, and dibutylamine, etc., may be cited. As the tertiary amine, trimethylamine, triethylamine, tripropylamine, tributylamine, and ethyldimethylamine, ethyldiisopropylamine, etc., may be cited. Furthermore, as the ionic acid for the electric double-layer capacitor, salt including the cation component of the above chemical formula (N), (P), (Q), and (R) forming the plastic crystal may be cited.

The polymer is polyethylene oxide (PEO), polypropylene oxide, polyester, polyethylene carbonate (PEC), PEC derivative, polypropylene carbonate, polytrimethylene carbonate, or copolymer of polytrimethylene carbonate and polycarbonate. These polymers may be used in single or in combination of two or more. Among these polymers, carbonate-based polymer is an example, and any aliphatic polycarbonate may be used. Furthermore, when two or more of polymers are used, each polymer may be in the state of monopolymer, or may be copolymer of two or more monomers.

An example method for producing the solid electrolyte including the plastic crystal is as follows. An alkali metal salt of first anion forming the plastic crystal, and halogenated cation are respectively dissolved in solvent. As the alkali metal, Na, K, Li, and Cs may be cited. As halogens, F, Cl, Br, and I may be cited. Water is preferable for the solvent. A metal salt solution of the anion is dropped to a solution of the halogenated cation little by little to cause the ion-exchange reaction. The equivalent molecular weight of the metal salt solution of the anion is added to the solution of the halogenated cation, and the solution is stirred.

At this time, by the ion exchange, the plastic crystal including the first anion and a halogenated alkali metal are produced. Since the plastic crystal is hydrophobic and the halogenated alkali metal is hydrophilic, the plastic crystal is present in the solid state in the aqueous solution and the halogenated alkaline metal is dissolved in the aqueous solution. An organic solvent, such as dichloromethane, is mixed to this aqueous solution in which the plastic crystal is present in the solid state. After the organic solvent such as dichloromethane was mixed to this aqueous solution, and the mixture solution is left standing still, the mixture solution is separated to a water layer and an organic solvent layer.

By removing the water layer from the mixture solution, the halogenated alkali metal is removed. This action is repeated several times, for example, five times. After the halogenated alkali metal was removed as such, the organic solvent such as dichloromethane is evaporated to obtain the plastic crystal including the first anion. Note that, when solvent such as dichloromethane is mixed to the aqueous solution and the mixture solution is not left standing still, participate of the plastic crystal including the first anion can be obtained, and this participate may be filtered, collected, washed by water, and then dried in vacuum condition.

The plastic crystal including the second anion can be obtained by the same method as that of the plastic crystal including the first anion. That is, an alkali metal salt of the second anion and the halogenated cation are respectively dissolved in solvent, the metal salt solution of the anion is dropped to the solution of the halogenated cation to cause the ion-exchange reaction, the organic solvent such as dichloromethane is mixed to the aqueous solution, and the water layer is removed.

The plastic crystal including the first anion and the plastic crystal including the second anion are each purified, and then are added to a vial by the molecular ratio of 1:1, and the ionic salt as the electrolyte is further added to the vial. It is preferable that the ionic salt is in an amount of 0.1 mol % or more and 50 mol % or less relative to the total amount of the plastic crystal. When the polymer is to be added, the polymer is added in this timing. Then, the organic solvent, such as acetonin and acetonitrile, in which the plastic crystal and the electrolyte can be dissolved is further added to the vial, to prepare an organic solvent solution in which the plastic crystal and the electrolyte are dissolved.

The organic solvent solution is casted to targets such as an active material layer of the electrode, a separator, or both, to which the solid electrolyte is adhered. After the casting, the target is left and dried under an environment with temperature where the organic solvent volatilizes, such as 80° C. to volatilize the organic solvent, and the remaining moisture, etc., is volatilized under an environment with temperature of, for example, 150° C. Thus, the solid electrolyte is formed on the target.

Note that the method for producing the solid electrolyte including the plastic crystal is not limited thereto, and various schemes can be used. For example, the powder plastic crystal and the powder electrolyte may be respectively dissolved in the organic solvent to prepare respective solution, and these solutions may be mixed with each other. The two types of the plastic crystal may be separately dissolved in the organic solvent or may be dissolved in the organic solvent at the same time. Furthermore, the electrolyte may be added to the organic solvent after the powder plastic crystal was dissolved in said organic solvent. Furthermore, the powder plastic crystal may be added to the organic solvent after the electrolyte was dissolved in said organic solvent. Then, the organic solvent may be casted on the target.

(Power Storage Device)

The power storage is formed by making a positive electrode and a negative electrode to face each other with the electrolyte layer therebetween. The separator is arranged between the positive electrode and the negative electrode to prevent the electrodes from contacting each other and to maintain the state of the solid electrolyte. However, the power storage device may be so-called separator-less if the solid electrolyte has enough thickness to prevent the electrodes from contacting each other and has hardness enough to maintain the state by itself.

The positive electrode and negative electrode of the electric double-layer capacitor is formed by forming the active material layer by a current collector. Metals having valve action such as aluminum foil, platinum, gold, nickel, titanium, copper, and carbon may be used as the current collector. A shape of the current collector may be arbitrary shape such as film, foil, plate, net, expanded metal, and cylinder. Furthermore, concaves and convexes may be formed on a surface of the current collector by etching, etc., or the surface of the current collector may be plane surface. Furthermore, surface treatment may be performed to attach phosphorus on the surface of the current collector.

One of the positive electrode and the negative electrode is a polar electrode. The active material layer of the polar electrode includes carbon material with porous structure having electric double-layer capacity. The solid electrolyte using the plastic material is particularly preferable for the electric double-layer capacitor having the active material layer with porous structure. Since the plastic material is soluble, it easily gets into the porous structure such that the filling rate to the active material layer is improved. In contrast, the filling rate to the active material layer is low for the solid electrolyte of sulfide and oxide. Therefore, the electric double-layer capacitor employing the plastic crystal can achieve both excellent filling rate to the porous structure and high ion conductivity, achieving large capacity and high output. Note that the other of the positive electrode and the negative electrode may be formed the active material layer including metal compound material and carbon material which produce Faraday reaction.

The carbon material in the polar electrode is mixed with a conductive aid and a binder, and is applied on the current collector by doctor-blade scheme, etc. The mixture of the carbon material, the conductive aid, and the binder may be formed into a sheet-shape and may be pressure-bonded to the current collector. Here, the porous structure is formed by gaps produced between primary particles and secondary particles when the carbon material has a particle-shape and is formed by gaps between fibers when the carbon material is fibrous.

As the carbon material of the active material layer in the polar electrode, natural plant tissue such as coconut husk, synthesized resin such as phenol, activated carbon made from fossil fuel as the source such as coal, coke, and pitch, carbon black such as ketjen black, acetylene black, and channel black, carbon nanohorn, amorphous carbon, natural graphite, synthetic graphite, graphitized ketjen black, mesoporous carbon, carbon nanotube, and carbon nanofiber, etc., may be cited. The specific surface area of the carbon material may be improved by activation process such as steam activation, alkali activation, zinc chloride activation, or electric field activation, and aperture process.

As the binder, for example, rubber such as fluorine-based rubber, diene-based rubber, and styrene-based rubber, fluorine-including polymer such as polytetrafluoroethylene and polyvinylidene fluoride, cellulose such as carboxymethyl cellulose and nitrocellulose, and others such as polyolefin resin, polyimide resin, acrylic resin, nitrile resin, polyester resin, phenol resin, polyvinyl acetate rein, polyvinyl alcohol resin, and epoxy resin may be cited. These binders may be used in single or in mixture of two or more.

As the conductive aid, ketjen black, acetylene black, natural/synthesized graphite, fibrous carbon, etc., may be used, and as the fibrous carbon, carbon nanotube and carbon nanofiber (hereinafter, CNF), etc., may be cited. The carbon nanotube may be single-walled carbon nanotube (SWCNT) that is one layer of graphene sheet, may be multi-walled carbon nanotube in which two layers or more of graphene sheet is curled up concentrically relative to the same axis and tube walls forms multi-layer, or both may be mixed.

A carbon coating layer including the conductive aid such as graphite is provided between the current collector and the active material layer. The carbon coating layer can be formed by applying a slurry including the conductive aid such as graphite and the binder, etc., and drying the applied slurry.

The positive and negative electrodes of the lithium-ion secondary battery is formed by forming the active material layer on the current collector. As the current collector, metals such as aluminum foil, platinum, gold, nickel, titanium, and copper, carbon, condictive polymer material such as polyaniline, polypyrrole, polythiophene, polyacetylene, poly para-phenylene, polyphenylenevinylene, polyacrylonitrile, and polyoxadiazole, and resin in which conductive filler is filled in non-conductive polymer material may be used. The shape of the current collector may be arbitrary shape such as film, foil, plate, net, expanded metal, and cylinder.

The active material is mixed with the binder, and is applied on the current collector by doctor-blade scheme, etc. The mixture of the carbon material and the binder may be formed into a sheet-shape and may be pressure-bonded to the current collector. The conductive carbon such as carbon black, acetylene black, ketjen black, and graphite that would be the conductive aid may be added to the active material layer, and the conductive aid is added to and kneaded with the active material and the binder, and is applied or pressure-bonded to the current collector.

As the active material of the positive electrode, metal compound particles that can occlude and release lithium ions may be cited, and layered-rock-salt-type LiMO₂, layered Li₂MnO₃-LiMO₂ solid solution, and spinel-type LiM₂O₄ (in which M in formula represents Mn, Fe, Co, Ni, or combinations thereof) may be cited. As detailed examples, LiCoO₂, LiNiO₂, LiNi_{4/5}CO_{1/5}O₂, LiNi_{1/3}Co_{1/3}Mn_{1/3}O₂, LiNi_{1/2}Mn_{1/2}O₂, LiFeO₂, LiMnO₂, Li₂MnO₃—LiCoO₂, Li₂MnO₃—LiNiO₂, Li₂MnO₃—LiNi_{1/3}CO_{1/3}Mn_{1/3}O₂, Li₂MnO₃—LiNi_{1/2}Mn_{1/2}O₂, Li₂MnO₃—LiNi_{1/2}Mn_{1/2}O₂—LiNi_{1/3}CO_{1/3}Mn_{1/3}O₂, and LiMn_{3/2}Ni_{1/2}O₄ may be cited. Furthermore, as the metal compound particle, sulfur and sulfide such as Li₂S, TiS₂, Mos₂, FeS₂, VS₂, and Sr_{1/2}V_{1/2}S₂, selenide such as NbSe₃, VSe₂, and NbSe₃, oxide such as Cr₂O₅, Cr₃O₈, VO₂, V₃O₈, V₂O₅, and V₆O₁₃, and other composite oxides such as LiNi_{0.8}CO_{0.15}Al_{0.05}O₂, LiVOPO₄, LiV₃O₅, LiV₃O₈, MoV₂O₈, Li₂FeSiO₄, Li₂MnSiO₄, LiFePO₄, LiFe_{1/2}Mn_{1/2}PO₄, LiMnPO₄, and Li₃V₂ (PO₄)₃ may be cited.

As the active material of the negative electrode, metal compound particles that can occlude and release lithium ions may be cited, and for example, oxides such as FeO, Fe₂O₃, Fe₃O₄, MnO, MnO₂, Mn₂O₃, Mn₃O₄, COO, CO₃O₄, NiO, Ni₂O₃, TiO, TiO₂, TiO₂ (B), TiNb₂O₇, Nb₂O₅, SnO, SnO₂, SiO₂, RuO₂, WO, WO₂, WO₃, MoO₃, and ZnO, metals such as Sn, Si, Al, and Zn, composite oxides such as LiVO₂, Li₃VO₄, Li₄Ti₅O₁₂, Sc₂TiO₅, Fe₂TiO₅, Li₂Na₂Ti₆O₁₄, Li₂BaTi₆O₁₄, and Li₂SrTi₆O₁₄, nitrides such as Li_{2.6}Co_{0.4}N, Ge₃N₄, Zn₃N₂, and Cu₃N, and sulfides such as Y₂Ti₂O₅S₂ and MoS₂ may be cited.

When the separator is used in the power storage device, as the separator, cellulose such as kraft, manila hemp, esparto, hemp, rayon, and combinations thereof, polyester-based resin such as polyethylene terephthalate, polybutylene terephthalate, polyethylene naphthalate, and derivatives thereof, polytetrafluoroethylene-based resin, polyvinylidene fluoride-based resins, vinylon-based resins, polyamide-based resins such as aliphatic polyamide, semi-aromatic polyamide, and fully aromatic polyamide, polyimide-based resins, polyethylene resins, polypropylene resins, trimethylpentane resins, polyphenylene sulfide based resins, and acryl resins may be cited, and these resins may be used in single or in mixture.

In such a power storage device, the plastic crystal and the ionic salt are dissolved in the solvent such as acetonitrile, and the mixture are casted to the active material layer and the separator. After the casting the mixture is left and dried under an environment with temperature such as 80° C. to volatilize the solvent, and remaining moisture, etc., is volatilized under an environment with temperature of, for example, 150° C. after the active material layers of the positive electrode and the negative electrode are faced with each other via the separator. Then, a lead electrode terminal is connected to the current collector of the positive electrode and the negative electrode, and is sealed by an outer casing, to produce the power storage device.

### Examples 1 to 10

The solid electrolytes for the electric double-layer capacitor of examples 1 to 10 were produced using the plastic crystal including two types of anions, and the ion conductivity of the solid electrolyte of each example was measured.

A solid electrolyte of example 1 was produced using a plastic crystal including N,N-hexafluoro-1,3-disulfonylamide anion (CFSA anion) and bis(trifluoromethanesulfonyl)amide anion (TFSA anion) in a molecular ratio of 1:1. A solid electrolyte of example 2 was produced using a plastic crystal including CFSA anion and bis(fluorosulfonyl)amide anion(FSA anion) in a molecular ratio of 1:1. A solid electrolyte of example 3 was produced using a plastic crystal including CFA anion and bis(pentafluoroethylsulfonyl)amide anion (BETA anion) in a molecular ratio of 1:1. A solid electrolyte of example 4 was produced using a plastic crystal including CFSA anion and tris(trifluoromethanesulfonyl)metanide anion (TFSM anion) in a molecular ratio of 1:1.

A solid electrolyte of example 5 was produced using a plastic crystal including TFSA anion and FSA anion in a molecular ratio of 1:1. A solid electrolyte of example 6 was produced using a plastic crystal including BETA anion and TFSM anion in a molecular ratio of 1:1. A solid electrolyte of example 7 was produced using a plastic crystal including TFSA anion and TFSM anion in a molecular ratio of 1:1. A solid electrolyte of example 8 was produced using a plastic crystal including FSA anion and BETA anion in a molecular ratio of 1:1. A solid electrolyte of example 9 was produced using a plastic crystal including FSA anion and TFSM anion in a molecular ratio of 1:1. A solid electrolyte of example 10 was produced using a plastic crystal including BETA anion and TFSM anion in a molecular ratio of 1:1.

As such, the solid electrolytes of examples 1 to 10 were produced by using the plastic crystal including different two anions selected from a group of various amide anions in which two hydrogen atoms of NH₂ anion are substituted with perfluoroalkylsulfonyl group, fluorosulfonyl group, or both, and tris(trifluoromethanesulfonyl)metanide anion.

The method for producing the solid electrolyte of each example was common as follows. Firstly, cations of each example forming the plastic crystal was N-ethyl-N-methylpyrrolidinium cation (P12 cation). That is, a plastic crystal formed by a first cation and P12 cation and a plastic crystal formed by a second cation and P12 cation was added to a vial by the molecular ratio of 1:1. Note that in the present examples, synthesized P12 CFSA plastic crystal, P12 TFSA plastic crystal (from Kanto Chemical Co., Inc.), synthesized P12 FSA plastic crystal, synthesized P12 BETA plastic crystal, and synthesized P12 TFSM plastic crystal powder were used.

7 mol % of TEMABF₄ (triethylmethylammonium-tetrafluoroborate) (from Tomiyama Pure Chemical Industries, Ltd.) that is the electrolyte relative to the total amount of the plastic crystal was further added to the vial, and acetonitrile (from FUJIFILM Wako Pure Chemical Corporation) was added so as to make the solid content concentration of the total plastic crystal and electrolyte to be 10 wt %. The acetonitrile solution was dropped on a glass separator, and was dried at 80° C. to evaporate acetonitrile. This evaporation operation was repeated three times. By this evaporation operation, the glass separator impregnated with the solid electrolyte was dried for 12 hours at 80° C. under vacuum environment, was further dried for three hours at 120° C. under vacuum environment, and was further dried for 2 hours at 50° C. under vacuum environment, to remove moisture, and the solid electrolyte of each example and each comparative example was obtained.

Then, the ion conductivity of each example was measured. That is, the grass separator impregnated with the solid electrolyte was sandwiched by two platinum electrodes, the two platinum electrode were faced with each other by an electrode holder to assemble 2-pole sealed cell (from Toyo System Co., Ltd.), the impedance was measure, and the ion conductivity was calculated from the measurement result of impedance and the thickness of the grass separator impregnated with the solid electrolyte. The measurement result of the ion conductivity is indicated in below table 1.

TABLE 1

| | | Plastic Crystal 1 | | Plastic Crystal 2 | | Ion |
|---|---|---|---|---|---|---|
| | | | Ion | | Ion | conductivity |
| | | | conductivity | | conductivity | of Example |
| | Electroyte | Type | (S/cm) | Type | (S/cm) | (S/cm) |
| Example 1 | TEMABF₄ | P12 CFSA | 1.70 × 10⁻⁷ | P12 TFSA | 9.80 × 10⁻⁷ | 1.10 × 10⁻³ |
| Example 2 | | P12 CFSA | 1.70 × 10⁻⁷ | P12 FSA | 1.06 × 10⁻⁵ | 2.54 × 10⁻⁵ |
| Example 3 | | P12 CFSA | 1.70 × 10⁻⁷ | P12 BETA | 4.90 × 10⁻⁶ | 2.83 × 10⁻⁴ |
| Example 4 | | P12 CFSA | 1.70 × 10⁻⁷ | P12 TFSM | 5.10 × 10⁻⁹ | 2.83 × 10⁻⁴ |
| Example 5 | | P12 TFSA | 9.80 × 10⁻⁷ | P12 FSA | 1.06 × 10⁻⁵ | l.73 × 10⁻³ |
| Example 6 | | P12 TFSA | 9.80 × 10⁻⁷ | P12 BETA | 4.90 × 10⁻⁶ | 1.43 × 10⁻⁵ |
| Example 7 | | P12 TFSA | 9.80 × 10⁻⁷ | P12 TFSM | 5.10 × 10⁻⁹ | 4.09 × 10⁻⁴ |
| Example 8 | | P12 FSA | 1.06 × 10⁻⁵ | P12 BETA | 4.90 × 10⁻⁶ | 1.59 × 10⁻³ |
| Example 9 | | P12 FSA | 1.06 × 10⁻⁵ | P12 TFSM | 5.10 × 10⁻⁹ | 5.48 × 10⁻⁵ |
| Example 10 | | P12 BETA | 4.90 × 10⁻⁶ | P12 TFSM | 5.10 × 10⁻⁹ | 1.61 × 10⁻⁴ |

Note that in Table 1, the ion conductivity of the solid electrolyte using the plastic crystal formed by one anion and P12 cation is also indicated. This solid electrolyte for comparison was produced by the same condition as the solid electrolyte of each example except that the plastic crystal was formed by one anion and P12 cation.

As indicated in Table 1, it is found that the ion conductivity of the solid electrolyte for electric double-layer capacitor of each example was improved by 2 digits in minimum and by 4 digits in maximum when compared with the solid electrolyte using the plastic crystal formed by one anion and P12 cation.

By this, it is found that the ion conductivity of the solid electrolyte using the plastic crystal including different two anions selected from a group of various amide anions in which two hydrogen atoms of NH₂ anion are substituted with perfluoroalkylsulfonyl group, fluorosulfonyl group, or both, and tris(trifluoromethanesulfonyl)metanide anion was improved even when said solid electrolyte was used for the electric double-layer capacitor.

### Examples 15 and 16

The solid electrolyte for electric double-layer capacitor of example 15 in which the ionic salt doped to the plastic crystal as the electrolyte was different from example 1 and of example 16 in which the ionic salt doped to the plastic crystal as the electrolyte was different from example 5 were produced. To produce the solid electrolyte of examples 15 and 16, 25 mol % of SBPBF₄ (spirobipyrrolidiniumtetrafluoroborate, from Tokyo Chemical Industry Co., Ltd.) that is the electrolyte relative to the total amount of the plastic crystal was further added to the vial, and acetonitrile was added so as to make the solid content concentration of the total plastic crystal and electrolyte to be 10 wt %. The solid electrolyte of example 15 was produced by the same condition as the solid electrolyte of example 1 except that the electrolyte was different, and the solid electrolyte of example 16 was produced by the same condition as the solid electrolyte of example 5 except that the electrolyte was different.

Then, the ion conductivity of the solid electrolyte of examples 15 and 16 was measured. The result is indicated in the below Table 2. Note that the measurement and calculation method for the ion conductivity was the same as examples 1 to 10.

TABLE 2

| | | Plastic Crystal 1 | | Plastic Crystal 2 | | Ion |
|---|---|---|---|---|---|---|
| | | | Ion | | Ion | conductivity |
| | | | Conductivity | | Conductivity | of Example |
| | Electroyte | Type | (S/cm) | Type | (S/cm) | (S/cm) |
| Example 15 | SBPBF₄ | P12 CFSA | 1.89 × 10⁻⁶ | P12 TFSA | 1.08 × 10⁻⁵ | 1.25 × 10⁻³ |
| Example 16 | | P12 FSA | 2.87 × 10⁻⁴ | P12 TFSA | 1.08 × 10⁻⁵ | 5.11 × 10⁻³ |

As indicated in Table 2, the ion conductivity of the solid electrolyte of examples 15 and 16 was improved by 1 digit in minimum and by 3 digits in maximum when compared with the solid electrolyte using the plastic crystal formed by one anion and P12 cation.

By this, it is found that the ion conductivity of the solid electrolyte using the plastic crystal including different two anions selected from a group of various amide anions in which two hydrogen atoms of NH₂ anion are substituted with perfluoroalkylsulfonyl group, fluorosulfonyl group, or both, and tris(trifluoromethanesulfonyl)metanide anion was improved regardless of the type of the electrolyte.

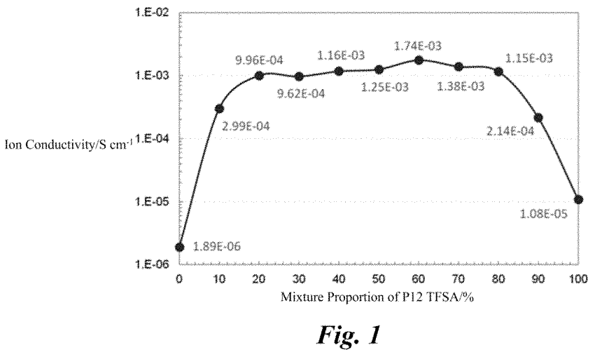

Furthermore, the mixture proportion (molecular ratio) of CFSA anion and TFSA anion of the solid electrolyte of example 15 was changed by each 10%, and the ion conductivity thereof was measured. The solid electrolyte of respective mixture ratio was the same as the solid electrolyte of example 15 except for the mixture ratio. The measurement result was indicated in FIG. 1. FIG. 1 is a graph in which the horizontal axis indicates the mixture proportion of the plastic crystal formed by TFSA anion and P12 cation and the vertical axis indicates the ion conductivity.

As illustrated in FIG. 1, the ion conductivity of the solid electrolyte was improved when compared with the solid electrolyte using the plastic crystal was formed by FSA anion and P12 cation, which has the largest ion conductivity, when the mixture proportion was within a range of 10% or more and 90% or less. Furthermore, as illustrated in FIG. 1, the ion conductivity of the solid electrolyte was improved when the mixture proportion was within a range of 20% or more and 80% or less. Note that, as indicated in Table 2, the ion conductivity of the solid electrolyte using the plastic crystal was formed by FSA anion and P12 cation was 2.87×10⁻⁴ S/cm.

That is, it is found that the ion conductivity was improved as long as two types of anions were mixed regardless of the mixture ratio. Furthermore, it is found that the ion conductivity was significantly improved when the mixture proportion was within the range of 20% or more and 80% or less.

### Examples 11 and 12

Next, the solid electrolyte for lithium-ion secondary battery of examples 11 and 12 were produced using the plastic crystal including two types of anions, and the ion conductivity of the solid electrolyte of each example was measured.

A solid electrolyte of example 11 was produced using the plastic crystal including CFSA anion and TSFA anion in a molecular ratio of 1:1. A solid electrolyte of example 12 was produced using the plastic crystal including FSA anion and TSFA anion in a molecular ratio of 1:1. The solid electrolyte of examples 11 and 12 was produced by the same condition as examples 1 to 10 including that the cation forming the plastic crystal of each example was N-ethyl-N-methyl pyrrolidinium (P12 cation), except that the electrolyte is different from examples 1 to 10. 5 mol % of LiTFSA that is the electrolyte relative to the total amount of the plastic crystal was added to the vial. The measurement result of the ion conductivity of examples 11 and 12 is indicated in the below Table 3.

TABLE 3

| | | Plastic Crystal 1 | | Plastic Crystal 2 | | Ion |
|---|---|---|---|---|---|---|
| | | | Ion | | Ion | conductivity |
| | | | Conductivity | | Conductivity | of Example |
| | Electroyte | Type | (S/cm) | Type | (S/cm) | (S/cm) |
| Example 11 | LiTESA | P12 CFSA | 1.0 × 10⁻⁵ | P12 TFSA | 2.5 × 10⁻⁶ | 8.7 × 10⁻⁴ |
| Example 12 | | P12 FSA | 2.7 × 10⁻⁵ | P12 TFSA | 2.5 × 10⁻⁶ | 1.8 × 10⁻³ |

Note that in Table 3, the ion conductivity of the solid electrolyte using the plastic crystal formed by one anion and P12 cation is also indicated. This solid electrolyte for comparison was produced by the same condition as the solid electrolyte of examples 11 and 12 except that the plastic crystal was formed by one anion and P12 cation.

As indicated in Table 3, it is found that the ion conductivity of the solid electrolyte for lithium-ion secondary battery of each example was improved by 2 digits in minimum and by 4 digits in maximum when compared with the solid electrolyte using the plastic crystal formed by one anion and P12 cation.

By this, it is found that the ion conductivity of the solid electrolyte using the plastic crystal including different two anions selected from a group of various amide anions in which two hydrogen atoms of NH₂ anion are substituted with perfluoroalkylsulfonyl group, fluorosulfonyl group, or both, and tris(trifluoromethanesulfonyl)metanide anion was improved even when said solid electrolyte was used for the lithium-ion secondary battery.

### Example 13 and 14

Next, the solid electrolyte for electric double-layer capacitor of examples 11 and 12 was produced using the plastic crystal including two types of anions, and the ion conductivity of the solid electrolyte of each example was measured.

A solid electrolyte of example 13 was produced using the plastic crystal including TFSA anion and tris(pentafluoroethyl)trifluorophosphate anion (FAP anion) in a molecular ratio of 1:1. A solid electrolyte of example 14 was produced using the plastic crystal including TFSA anion and hexafluorophosphate anion (PF₆) in a molecular ratio of 1:1. In the present examples, synthesized P12 FAP plastic crystal and synthesized P12 PF₆ plastic crystal (from Tokyo Chemical Industry Co., Ltd.) were used.

That is, the plastic crystal included two types of anions selected from a first group and a PB-based second group, and the first group was various amide anions in which two hydrogen atoms of NH₂ anion was substituted with perfluoroalkylsulfonyl, fluorosulfonyl, or both, and tris(trifluoromethanesulfonyl)metanide anion, and the PB-based second group was hexafluorophosphate anion, various perfluoroalkylphosphate anions in which a part of fluorine atoms of PF₆ was substituted with fluoroalkyl group, and various perfluoroalkylborate anions in which a part of fluorine atoms of BF₄ anion was substituted with fluoroalkyl group.

The solid electrolyte of examples 13 and 14 was produced by the same condition as examples 1 to 10 including that the cation forming the plastic crystal of each example was N-ethyl-N-methyl pyrrolidinium (P12 cation), except that the electrolyte is different from examples 1 to 10. 7 mol % of TEMATFSA (triethylmethylammonium-bis(trifluoromethanesulfonyl)amide) that is the electrolyte relative to the total amount of the plastic crystal was added to the vial. The measurement result of the ion conductivity of examples 13 and 14 is indicated in the below Table 4.

TABLE 4

| | | Plastic Crystal 1 | | Plastic Crystal 2 | | Ion |
|---|---|---|---|---|---|---|
| | | | Ion | | Ion | conductivity |
| | | | Conductivity | | Conductivity | of Example |
| | Electroyte | Type | (S/cm) | Type | (S/cm) | (S/cm) |
| Example 13 | TEMATFSA | P12 TFSA | 9.9 × 10⁻⁷ | P12 FAP | 8.2 × 10⁻⁷ | 7.9 × 10⁻⁴ |
| Example 14 | | P12 TFSA | 9.9 × 10⁻⁷ | P12 PF₆ | 5.7 × 10⁻⁷ | 5.9 × 10⁻⁶ |

Note that in Table 4, the ion conductivity of the solid electrolyte using the plastic crystal formed by one anion and P12 cation is also indicated. This solid electrolyte for comparison was produced by the same condition as the solid electrolyte of each example except that the plastic crystal was formed by one anion and P12 cation.

As indicated in Table 4, it is found that the ion conductivity of the solid electrolyte of each example was improved from about five times to 2 digits when compared with the solid electrolyte using the plastic crystal formed by one anion and P12 cation.

Here, comparative examples 1 to 3 in which the solid electrolyte of the plastic crystal including two anions selected from the PB-based second group were produced to compare with examples 13 to 14 using the plastic crystal including one anion selected from the first group and one anion selected from the PB-based second group.

A solid electrolyte of comparative example 1 was produced using PF₆ anion and FAP anion selected from the PB-based second group in a molecular ratio of 1:1. A solid electrolyte of comparative example 2 was produced using PF₆ anion and BF₄ anion selected from the PB-based second group in a molecular ratio of 1:1. A solid electrolyte of comparative example 3 was produced using BF₄ anion and FAP anion selected from the PB-based second group in a molecular ratio of 1:1. The solid electrolyte of comparative examples 1 to 3 was produce by the same condition as examples 13 to 14 including that the cation forming the electrolyte and plastic crystal. Note that, in the present examples, P12 PF₆ plastic crystal (from Tokyo Chemical Industry Co., Ltd.), P12 BF₄ plastic crystal (from Tokyo Chemical Industry Co., Ltd.), and synthesized P12 FAP plastic crystal powder were used. The measurement result of the ion conductivity of comparative examples 1 to 3 is indicated in the below Table 5.

TABLE 5

| | | Plastic Crystal 1 | | Plastic Crystal 2 | | Ion |
|---|---|---|---|---|---|---|
| | | | Ion | | Ion | conductivity |
| | | | Conductivity | | Conductivity | of Example |
| | Electroyte | Type | (S/cm) | Type | (S/cm) | (S/cm) |
| Comparative | TEMATFSA | P12 PF₆ | 5.7 × 10⁻⁷ | P12 FAP | 8.2 × 10⁻⁷ | 6.3 × 10⁻⁷ |
| Example 1 | | | | | | |
| Comparative | | P12 PF₆ | 5.7 × 10⁻⁷ | P12 BF₄ | 5.4 × 10⁻⁶ | 1.0 × 10⁻⁷ |
| Example 2 | | | | | | |
| Comparative | | P12 BF₄ | 5.4 × 10⁻⁶ | P12 FAP | 8.2 × 10⁻⁷ | 8.3 × 10⁻⁷ |
| Example 3 | | | | | | |

Note that in Table 5, the ion conductivity of the solid electrolyte using the plastic crystal formed by one anion and P12 cation is also indicated. This solid electrolyte for comparison was produced by the same condition as the solid electrolyte of each example except that the plastic crystal was formed by one anion and P12 cation.

As indicated in Table 5, it is found that the ion conductivity of the solid electrolyte of each example did not change or rather decreased when compared with the solid electrolyte using the plastic crystal formed by one anion and P12 cation.

By this, in the case the first group was various amide anions in which two hydrogen atoms of NH₂ anion was substituted with perfluoroalkylsulfonyl, fluorosulfonyl, or both, and tris(trifluoromethanesulfonyl)metanide anion, and the PB-based second group was hexafluorophosphate anion, various perfluoroalkylphosphate anions in which a part of fluorine atoms of PF₆ was substituted with fluoroalkyl group, and various perfluoroalkylborate anions in which a part of fluorine atoms of BF₄ anion was substituted with fluoroalkyl group, it is found that the ion conductivity of the solid electrolyte using the plastic crystal including two types of anions selected from the first group and the PB-based second group was improved.

### Example 17 to 20

Furthermore, the solid electrolyte for electric double-layer capacitor of examples 17 to 20 was produced using the plastic crystal including two types of anions, and the ion conductivity of the solid electrolyte of each example was measured.

A solid electrolyte of example 17 was produced using the plastic crystal including CFSA anion and nonafluorobutanesulfonic acid anion (NFS anion) in a molecular ratio of 1:1. A solid electrolyte of example 18 was produced using the plastic crystal including TFSA anion and NFS anion in a molecular ratio of 1:1.

The solid electrolyte of examples 17 and 18 was produced by the same condition as examples 1 to 10 including that the cation forming the plastic crystal of each example was N-ethyl-N-methyl pyrrolidinium (P12 cation) and that TEMABF₄ (triethylmethylammonium-tetrafluoroborate) was added to the vial as the electrolyte, except that the mixture proportion of the electrolyte is different from examples 1 to 10. 25 mol % of TEMABF₄ relative to the total amount of the plastic crystal was added to the vial.

Next, a solid electrolyte of example 19 was produced using the plastic crystal including CFSA anion and nonafluorobutanesulfonic acid anion (NFS anion) in a molecular ratio of 1:1. A solid electrolyte of example 20 was produced using the plastic crystal including TFSA anion and NFS anion in a molecular ratio of 1:1.

The solid electrolyte of examples 19 and 20 was produced by the same condition as examples 1 to 10 including that the cation forming the plastic crystal of each example was N-ethyl-N-methyl pyrrolidinium (P12 cation), except that the mixture proportion of the electrolyte is different from examples 1 to 10. 25 mol % of SBPBF₄ (spirobipyrrolidiniumtetrafluoroborate) that is the electrolyte of example 19 and 20 was added to the vial.

That is, the plastic crystal of examples 17 to 20 included two types of anions selected from the first group and a S-based second group, and the first group was various amide anions in which two hydrogen atoms of NH₂ anion was substituted with perfluoroalkylsulfonyl, fluorosulfonyl, or both, and tris(trifluoromethanesulfonyl)metanide anion, and the S-based second group was a group of various perfluoroalkylsulfonic acid anions in which hydrocarbon group extending from sulfonic acid skeleton was substituted with perfluoroalkyl group.

The measurement result of the ion conductivity of examples 17 and 18 is indicated in the below Table 6. Note that in Table 6, the ion conductivity of the solid electrolyte using the plastic crystal formed by one anion and P12 cation is also indicated. This solid electrolyte for comparison was produced by the same condition as the solid electrolyte of each example except that the plastic crystal was formed by one anion and P12 cation.

TABLE 6

| | | Plastic Crystal 1 | | Plastic Crystal 2 | | Ion |
|---|---|---|---|---|---|---|
| | | | Ion | | Ion | conductivity |
| | | | Conductivity | | Conductivity | of Example |
| | Electroyte | Type | (S/cm) | Type | (S/cm) | (S/cm) |
| Example 17 | TEMABF₄ | P12 CFSA | 1.70 × 10⁻⁷ | P12 NFS | 3.18 × 10⁻⁸ | 1.29 × 10⁻⁴ |
| Example 18 | | P12 TFSA | 9.8 × 10⁻⁷ | P12 NFS | 3.18 × 10⁻⁸ | 1.59 × 10⁻³ |

As indicated in Table 6, it is found that the ion conductivity of the solid electrolyte of each example was improved from about 3000 times when compared with the solid electrolyte using the plastic crystal formed by one anion and P12 cation.

Furthermore, the measurement result of the ion conductivity of examples 19 and 20 is indicated in the below Table 7. Note that in Table 7, the ion conductivity of the solid electrolyte using the plastic crystal formed by one anion and P12 cation is also indicated. This solid electrolyte for comparison was produced by the same condition as the solid electrolyte of each example except that the plastic crystal was formed by one anion and P12 cation.

TABLE 7

| | | Plastic Crystal 1 | | Plastic Crystal 2 | | Ion |
|---|---|---|---|---|---|---|
| | | | Ion | | Ion | conductivity |
| | | | Conductivity | | Conductivity | of Example |
| | Electroyte | Type | (S/cm) | Type | (S/cm) | (S/cm) |
| Example 19 | SBPBF₄ | P12 CFSA | 1.89 × 10⁻⁶ | P12 NFS | 3.11 × 10⁻⁸ | 1.44 × 10⁻³ |
| Example 20 | | P12 TFSA | 1.08 × 10⁻⁵ | P12 NFS | 3.11 × 10⁻⁸ | 8.20 × 10⁻⁴ |

As indicated in Table 7, it is found that the ion conductivity of the solid electrolyte of each example was improved about 100 times in minimum when compared with the solid electrolyte using the plastic crystal formed by one anion and P12 cation.

By this, in the case the first group was various amide anions in which two hydrogen atoms of NH₂ anion was substituted with perfluoroalkylsulfonyl, fluorosulfonyl, or both, and tris(trifluoromethanesulfonyl)metanide anion, and the S-based second group was a group of various perfluoroalkylsulfonic acid anions in which hydrocarbon group extending from sulfonic acid skeleton was substituted with perfluoroalkyl group, it is found that the ion conductivity of the solid electrolyte using the plastic crystal including two types of anions selected from the first group and the S-based second group was improved.

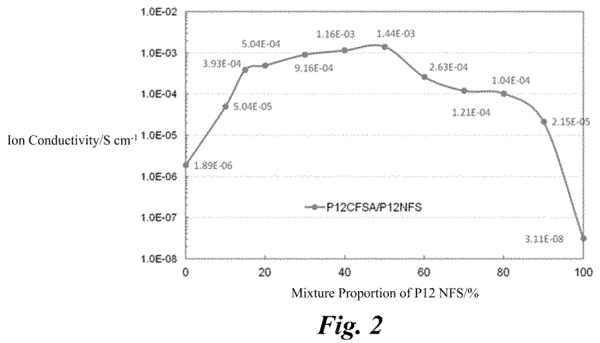

Furthermore, the mixture proportion (molecular ratio) of CFSA anion and NFS anion of the solid electrolyte of example 19 was changed to various proportions, and the ion conductivity thereof was measured. In detail, NFS anion was changed to 0%, 10%, 20%, 30%, 40%, 50%, 60%, 70%, 80%, 90%, and 100% in a molecular ratio relative to the total amount of CFSA anion and NFS anion. The measurement result was indicated in FIG. 2. FIG. 2 is a graph in which the horizontal axis indicates the mixture proportion of the plastic crystal formed by TFSA anion and P12 cation and the vertical axis indicates the ion conductivity.

As illustrated in FIG. 2, the ion conductivity of the solid electrolyte was improved when the mixture proportion of NFS anion was within a range of 10% or more and 90% or less. Furthermore, the ion conductivity of the solid electrolyte when the mixture proportion of NFS anion was within a range of 20% or more and 80% or less was improved two times as much as the case where the mixture proportion of NFS anion was within a range of 10% or more and 90% or less. Furthermore, particularly excellent ion conductivity was expressed when the mixture proportion of NFS anion was within a range of 15% or more and 60% or less.

That is, it is found that the ion conductivity was improved as long as two types of anions were mixed regardless of the mixture ratio. Furthermore, it is found that the ion conductivity was significantly improved when the mixture proportion was within the range of 15% or more and 80% or less. However, in the case of the combination including NFS anion, it is found that the mixture ratio of NFS anion was particularly preferable to be within the range of 15% or more and 60% or less.

### Example 21

The above-described measurement test for the ion conductivity was performed under the temperature environment of 25° C. Next, the ion conductivity of each solid electrolyte was measured at normal temperature and at low temperature range. Firstly, the solid electrolyte of example 21 in which CFSA anion and NFS anion in the equivalent molecular weight were used as the anion and P12 was used as the cation was produced. Also, the solid electrolyte of example 21 in which CFSA anion and TFSA anion in the equivalent molecular weight were used as the anion and P12 was used as the cation was used for comparison.

Example 21 was produced by the same condition as the solid electrolyte of each example such as examples 1 to 10. In both examples 21 and 15, 25 mol % of SBPBF₄ (spirobipyrrolidiniumtetrafluoroborate) relative to the total amount of the plastic crystal was added to the vial.

Furthermore, the mixture proportion (molecular ratio) of CFSA anion and NFS anion of the solid electrolyte of example 21 was changed to various proportions, and the ion conductivity thereof was measured. In detail, the molecular ratio of P12 CFSA that is the plastic crystal (A) formed by CFSA anion and p12 cation, and the plastic crystal (B) formed by NFS anion and p12 cation was changed to A:B=9:1, 8.5:1.5, 8:2, 7:3, 6:4, 5:5, 4:6, 3:7, 2:8, and 1:9.

The solid electrolyte of examples 21 and 15 were exposed to the temperature environment of 0° C. and 25° C., and the ion conductivity thereof was measured. The result was indicated in the below Table 8.

TABLE 8

| | Example 21 | | | | | |
|---|---|---|---|---|---|---|
| Ratio | 9:1 | 8.5:1.5 | 8:2 | 7:3 | 6:4 | 5:5 |
| P12 CFSA: | | | | | | |
| P12 NFS | | | | | | |
| 25° C. | 5.04 × 10⁻⁵ | 3.93 × 10⁻⁵ | 5.04 × 10⁻⁴ | 9.16 × 10⁻⁴ | 1.16 × 10⁻⁵ | 1.44 × 10⁻⁵ |
| 0° C. | 8.36 × 10⁻⁷ | 8.28 × 10⁻⁶ | 1.18 × 10⁻⁵ | 3.70 × 10⁻⁵ | 4.95 × 10⁻⁵ | 1.01 × 10⁻⁵ |
| | | Example 21 | | | | Example 15 |
| | Ratio | 4:6 | 3:7 | 2:8 | 1:9 | 5:5 |
| | P12 CFSA: | | | | | |
| | P12 NFS | | | | | |
| | 25° C. | 2.63 × 10⁻³ | 1.21 × 10⁻⁴ | 1.04 × 10⁻⁴ | 2.15 × 10⁻⁵ | 1.25 × 10⁻³ |
| | 0° C. | 9.97 × 10⁻⁶ | 3.38 × 10⁻⁶ | 3.34 × 10⁻⁶ | 5.58 × 10⁻² | 1.38 × 10⁻⁶ |

As indicated in Table 8, under the temperature environment of 25° C., when the mixture proportion of the molecular weight CFSA anion and FNS anion was equivalent, that is, when (A):(B)=5:5 in Table 8, the ion conductivity of examples 15 and 21 was equivalent. However, except for the case in which (A):(B)=5:5, the ion conductivity of example 21 was lower than that of example 15.

In particular, under the temperature environment of 0° C. and when (A):(B)=8:2 to 5:5 in Table 8, the ion conductivity of example 21 was 10 times to 100 times higher than that of the solid electrolyte of example 22. In other word, under the temperature environment of ° C., the solid electrolyte of example 21 had the ion conductivity significantly higher than the solid electrolyte of example 15 when the mixture proportion (molecular ratio) of NFS anion was within a range of 20% or more and 50% or less relative to the total amount of CFSA anion and NFS anion.

The solid electrolyte of example 21 was formed by the plastic crystal in which anion of the first group and perfluoroalkylsulfonic acid anion of the S-based second group were combined. By this, in the case the first group was various amide anions in which two hydrogen atoms of NH₂ anion was substituted with perfluoroalkylsulfonyl, fluorosulfonyl, or both, and tris(trifluoromethanesulfonyl)metanide anion, and the S-based second group was a group of various perfluoroalkylsulfonic acid anions in which hydrocarbon group extending from sulfonic acid skeleton was substituted with perfluoroalkyl group, it is found that the ion conductivity of the solid electrolyte using the plastic crystal including two types of anions selected from the first group and the S-based second group in the low temperature environment was improved.

### Example 22

A solid electrolyte of example 22 was produced using the plastic crystal including CFSA anion and TFSA anion in a molecular ratio of 1:1. The cation forming the plastic crystal was P12 cation. That is, the plastic crystal formed by CFSA anion and P12 cation and the plastic crystal formed by TFSA anion and P12 cation were added to the vial in a molecular ration of 1:1. TEMABF₄ that is the electrode was further added to the vial, and acetonitrile was further added to the vial. 7 mol % of TEMABF₄ relative to the total amount of the plastic crystal was added, and was dissolved in acetonitrile so that the concentration thereof was 10 wt %.

The electric double-layer capacitor was produced using the solid electrolyte of example 22. That is, the solution of the plastic crystal and electrolyte was casted on the active material layer of the polar electrode of the positive and negative electrode and the separator, and the solvent was volatilized under the temperature environment of 80° C. The active material layer that is the activated carbon was formed into a sheet-shape and was bonded to the aluminum-type current collector. The separator was non-woven cloth. Then, the active material layer of the positive and negative electrode was arranged to face with each other, and was exposed for two hours at the temperature of 150° C. under the vacuum environment, and the remaining moisture was removed. Finally, a lead electrode terminal is connected to the current collector of the positive electrode and the negative electrode, and is sealed in the laminated film. Then, constant voltage of 2.6 V was applied to the laminated cell under the temperature environment of 25° C. to perform aging processing for 12 hours. By this, the electric double-layer capacitor of example 22 was produced.

The electric double-layer capacitor of comparative example 4 was produced for comparison with the electric double-layer capacitor of example 22. The electric double-layer capacitor of comparative example 4 was different from example 22 in that the plastic crystal was not a mixture of two types but was a single plastic crystal formed by TFSA anion and P12 cation. Other method and condition for production, such as adding 7 mol % of TEMABF₄ relative to the plastic crystal, were the same as example 22.

Direct current internal resistance (DCIR) of the electric double-layer capacitor of example 22 and comparative example 4 was measured. The direct current internal resistance was calculated from IR drop right after the capacitor had been charged to 2.5 V under the temperature environment of 25° C. The result is indicated in the below Table 9.

TABLE 9

| | Electrolyte in | Plastic | Plastic | |
|---|---|---|---|---|
| | Plastic Crystal | Crystal 1 | Crystal 1 | DCIR (Ω) |
| Example 22 | 7 mol % | P12 CFSA | P12 TFSA | 5.9 |
| | TEMA BF₄ | | | |
| Comparative | 7 mol % | P12 TFSA | — | 6500 |
| Example 5 | TEMA BF₄ | | | |

As indicated in Table 9, the DCIR of the electric double-layer capacitor of example 22 decreased by approximately 1/1101 when compared with comparative example 4. Accordingly, it is found that the ion conductivity of the solid electrolyte largely affects the DCIR of the power storage device, and by forming the plastic crystal by selecting two anions from the first group, by selecting one anion each from the first group and the PB-based second group, or by selecting one anion each from the first group and the S-based second group, the ion conductivity of the solid electrolyte formed by the plastic crystal was improved, and this improvement of the ion conductivity can largely affect the DCIR of the power storage device, and can reduce the DCIR.

1. A solid electrolyte comprising:
a plastic crystal to which an electrolyte is doped,
wherein the plastic crystal includes two different types of anions selected from a group of various amide anions in which two hydrogen atoms of NH₂ anion are substituted with perfluoroalkyl sulfonyl group, fluorosulfonyl group, or both, and tris(trifluoromethanesulfonyl)metanide anion.

2. A solid electrolyte comprising:
a plastic crystal to which an electrolyte is doped,
wherein:
the plastic crystal includes anions selected one each from a first group and a second group,
the first group is a group of various amide anions in which two hydrogen atoms of NH₂ anion is substituted with perfluoroalkylsulfonyl, fluorosulfonyl, or both, and tris(trifluoromethanesulfonyl)metanide anion, and
the second group is a group of hexafluorophosphate anion, various perfluoroalkylphosphate anions in which a part of fluorine atoms of PF₆ is substituted with fluoroalkyl group, and various perfluoroalkylborate anions in which a part of fluorine atoms of BF₄ anion is substituted with fluoroalkyl group.

3. A solid electrolyte comprising:
a plastic crystal to which an electrolyte is doped,
wherein:
the plastic crystal includes anions selected one each from a first group and a second group,
the first group is a group of various amide anions in which two hydrogen atoms of NH₂ anion is substituted with perfluoroalkylsulfonyl, fluorosulfonyl, or both, and tris(trifluoromethanesulfonyl)metanide anion, and
the second group is a group of various perfluoroalkylsulfonic acid anions in which hydrocarbon group extending from sulfonic acid skeleton is substituted with perfluoroalkyl group.

4. The solid electrolyte according to claim 1, wherein the various amide anions is various bis(perfluoroalkylsulfonyl)amide anions represented by the below chemical formula (A), bis(fluorosulfonyl)amide anion, and various N-(fluorosulfonyl)-N-(perfluoroalkylsulfonyl)amide anions, N,N-hexafluoro-1,3-disulfonylaminde anion represented by the below chemical formula (B), and N,N-pentafluoro-1,3-disulfonylamide represented by the below chemical formula (C). 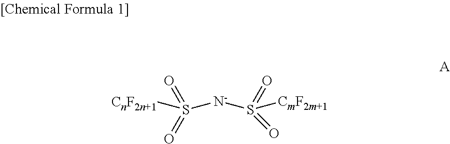
[In the formula, n and m are integers equal to or greater than 0]

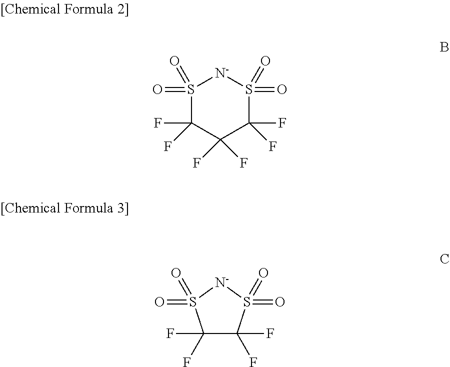 [SMILES: O=S1(=O)[N-]S(=O)(=O)C(F)(F)C(F)(F)C1(F)F ; O=S1(=O)[N-]S(=O)(=O)C(F)(F)C1(F)F]

5. The solid electrolyte according to claim 2, wherein:
the various perfluoroalkylphosphate anions are tris(fluoroalkyl)trifluorophosphate anion represented by the below chemical formula (D), and
the various perfluoroalkylborate anions are mono(fluoroalkyl)trifluoroborate anion represented by the below chemical formula (E) and bis(fluoroalkyl)fluoroborate anion. 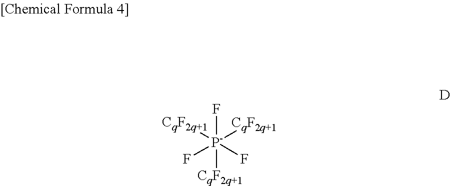
[In the formula, q is an integer equal to or greater than 1] 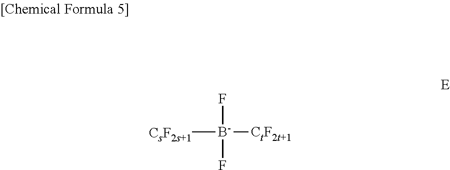
[In the formula, s is an integer equal to or greater than 0, t is an integer equal to or greater than 1]

6. The solid electrolyte according to claim 3, wherein the various perfluoroalkylsulfonic acid anions are trifluoromethanesulfonic acid anion represented by the below chemical formula (Z), pentafluoroethylsulfonic acid anion, heptafluoropropanesulfonic acid anion, and nonafluorobutanesulfonic acid anion. 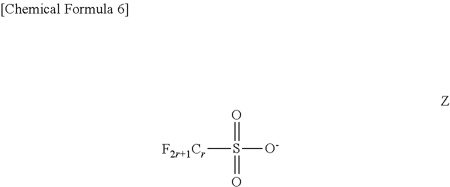
[In the formula, r is an integer equal to or greater than 1 and equal to or smaller than 4]

7. The solid electrolyte according to claim 1, wherein a mixture ratio of the two different types of anions is within a range of 10:90 to 90:10 in molecular ratio.

8. The solid electrolyte according to claim 1, wherein a mixture ratio of the two different types of anions is within a range of 20:80 to 80:20 in molecular ratio.

9. The solid electrolyte according to claim 3, wherein a mixture ratio (A):(B) of the anion (A) selected from the first group and the anion (B) selected from the group of the various perfluoroalkylsulfonic acid anions that are a second group may be in a range of 85:15 to 20:80 in molecular ratio.

10. The solid electrolyte according to claim 3, wherein a mixture ratio (A):(B) of the anion (A) selected from the first group and the anion (B) selected from the group of the various perfluoroalkylsulfonic acid anions that are a second group may be in a range of 80:20 to 50:50 in molecular ratio.

11. A power storage device comprising:
the solid electrolyte according to claim 1; and
two electrodes facing each other via the solid electrolyte.

12.-15. (canceled)

16. The solid electrolyte according to claim 2, wherein the various amide anions is various bis(perfluoroalkylsulfonyl)amide anions represented by the below chemical formula (A), bis(fluorosulfonyl)amide anion, and various N-(fluorosulfonyl)-N-(perfluoroalkylsulfonyl)amide anions, N,N-hexafluoro-1,3-disulfonylaminde anion represented by the below chemical formula (B), and N,N-pentafluoro-1,3-disulfonylamide represented by the below chemical formula (C). 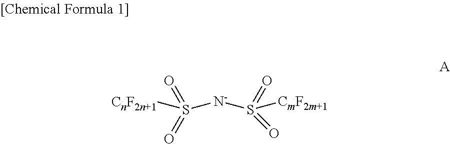
[In the formula, n and m are integers equal to or greater than 0]

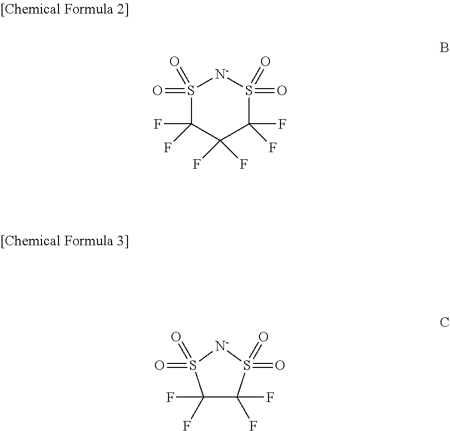 [SMILES: O=S1(=O)[N-]S(=O)(=O)C(F)(F)C(F)(F)C1(F)F ; O=S1(=O)[N-]S(=O)(=O)C(F)(F)C1(F)F]

17. The solid electrolyte according to claim 2, wherein a mixture ratio of the two types of anions is within a range of 10:90 to 90:10 in molecular ratio.

18. The solid electrolyte according to claim 2, wherein a mixture ratio of the two types of anions is within a range of 20:80 to 80:20 in molecular ratio.

19. A power storage device comprising:
the solid electrolyte according to claim 2; and
two electrodes facing each other via the solid electrolyte.

20. The solid electrolyte according to claim 3, wherein the various amide anions is various bis(perfluoroalkylsulfonyl)amide anions represented by the below chemical formula (A), bis(fluorosulfonyl)amide anion, and various N-(fluorosulfonyl)-N-(perfluoroalkylsulfonyl)amide anions, N,N-hexafluoro-1,3-disulfonylaminde anion represented by the below chemical formula (B), and N,N-pentafluoro-1,3-disulfonylamide represented by the below chemical formula (C). 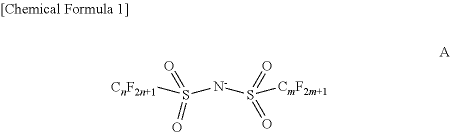
[In the formula, n and m are integers equal to or greater than 0]

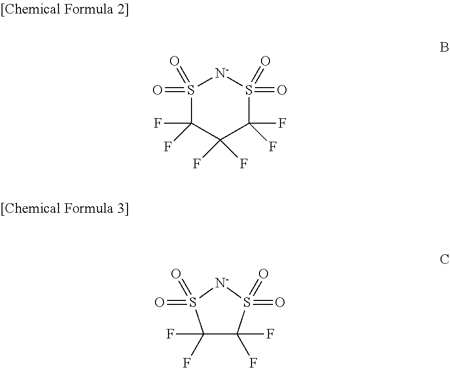 [SMILES: O=S1(=O)[N-]S(=O)(=O)C(F)(F)C(F)(F)C1(F)F ; O=S1(=O)[N-]S(=O)(=O)C(F)(F)C1(F)F]

21. The solid electrolyte according to claim 3, wherein a mixture ratio of the two types of anions is within a range of 10:90 to 90:10 in molecular ratio.

22. The solid electrolyte according to claim 3, wherein a mixture ratio of the two types of anions is within a range of 20:80 to 80:20 in molecular ratio.

23. A power storage device comprising:
the solid electrolyte according to claim 3; and
two electrodes facing each other via the solid electrolyte.
